(19) United States
(12) Patent Application Publication
(10) Pub. No.: US 2024/0343842 A1
(43) Pub. Date: Oct. 17, 2024

(54) OLEFIN POLYMERISATION CATALYST AND PROCESS FOR MANUFACTURING THEREOF

(71) Applicant: SABIC GLOBAL TECHNOLOGIES B.V., BERGEN OP ZOOM (NL)

(72) Inventors: Yahya Banat, Riyadh (SA); Lidong Li, Riyadh (SA); Nasser Abdullah AlSaif, Riyadh (SA); Mohammad Al-Shibel, Riyadh (SA)

(21) Appl. No.: 18/682,030

(22) PCT Filed: Jul. 19, 2022
(86) PCT No.: PCT/EP2022/070223

§ 371 Date: Feb. 7, 2024

(30) Foreign Application Priority Data
Aug. 24, 2021 (EP) 21192863.5

(51) Int. Cl. C08F 4/6592; C08F 4/02; C08F 4/642

(52) U.S. Cl. CPC C08F 4/65925; C08F 4/025; C08F 4/6428

(57) ABSTRACT

Process for producing a supported metallocene catalyst system includes: (i) preparing mixture (a) by mixing a metallocene with a cocatalyst; (ii) preparing mixture (b) by reacting an aluminium (II) with an amine (III)t;

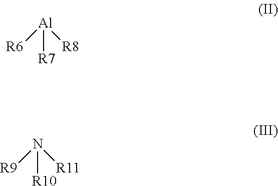

wherein each R6 and R10 is hydrogen or a C1-30 hydrocarbon; R7, R8, and R11 are C1-30 hydrocarbon; R9 is hydrogen or a functional moiety comprising at least one active hydrogen; (iii) providing a support material, into a reaction vessel; (iv) providing a solvent into the reaction vessel; (v) supplying mixture (a) and mixture (b) to the reaction vessel; (vi) subjecting the contents of the reaction vessel to a temperature of >60° C. for a period of >3 hrs to obtain a supported catalyst system; and (vii) removing the solvent from the supported catalyst system. Such process allows for the production of a supported metallocene catalyst system having reduced fouling in olefin polymerisation.

### CROSS REFERENCE TO RELATED APPLICATIONS

This application is a National Stage application of PCT/EP2022/070223, filed Jul. 19, 2022, which claims the benefit of European Application No. 21192863.5, filed Aug. 24, 2021, both of which are incorporated by reference in their entirety herein.

### FIELD

The present invention relates to an improved olefin polymerisation catalyst and a process for manufacturing thereof. In particular, the invention relates to a supported single-site olefin polymerisation catalyst with improved aluminium content.

### BACKGROUND

Olefin-based polymers are materials that are presently produced globally on large industrial scale, forming the most abundantly manufactured polymer materials. A large majority of these olefin-based polymers are produced via catalysed polymerisation processes. In such processes, the nature and composition of the catalyst allows for manufacturing of a wide array of polymer products, each having its particular set of desirable material characteristics. The choice of catalyst also has a significant influence on the economics and reliability of the polymerisation processes. Accordingly, there is a large variety of catalysts available and developed to accommodate for these material and process needs.

A particular category of catalysts that has been developed for use in olefin polymerisation processes is the category of single-site catalysts, particularly metallocene catalysts. These catalysts allow for the production of polymers based on certain olefins, particularly ethylene and propylene, with well-defined molecular structure. Accordingly, there is great demand and interest in these catalysts. Metallocene catalysts include complexes comprising two cyclopentadienyl moieties or two ligands comprising a cyclopentadienyl moiety. Further examples of single-site catalysts include bridged or unbridged metallocenes, mono-cyclopentadienyl containing complexes, late transition metal containing complexes, and metal complexes with one or more phosphinimine cyclooctatetraendiyl, imides, and phenoxy imines.

In certain of the polymerisation processes that are employed to produce polymers based on olefins such as ethylene and propylene, it is desired if not required that the catalysts that are used in such processes are supported catalyst systems. In such supported catalyst systems, an inert carrier or support is laden with catalyst moieties that are bound to the surface of the support.

Such supported catalyst systems may for example be used in gas-phase ethylene and propylene polymerisation processes, which constitute highly efficient, large-scale polymerisation processes. In such processes, improvements in activity, productivity, reliability and product quality are paramount to successful commercial operation. It is therefore that a global driver for improvement of the catalyst systems that are to be employed in these processes persists.

A particular aspect that is essential for reliable, continuous and high-quality polymerisation processes, in particular for gas-phase olefin polymerisation processes such as gas-phase ethylene polymerisation processes, is that the quantity of sheeting and fouling that occurs in the polymerisation reactor is minimised.

In particular, when using single-site catalysts, the gas-phase olefin polymerisation processes and slurry olefin polymerisation processes are prone to occurrence of such problems. Fouling on the walls of the reactor and/or reactor components may result in serious problems including poor heat transfer, poor particle morphology, and undesirable reactor shutdowns.

By fouling herein is meant the sticking of formation, for example in the form of particles, on the inside wall and/or other components on the inside of the reactor. A number of factors may contribute to occurrence of fouling. For example, the pores of the catalyst support material may contain residual solvent at the stage of deposition of the catalyst material onto the support. The presence of such residual solvent may prevent the catalyst material from securely anchoring itself onto the support or into the pores of the support. Thus, when the supported catalyst is added to the reaction polymerization vessel, the catalyst material may disassociate from the support, and may migrate to the reactor walls where monomer can polymerise therefrom and cause fouling. Also, when aluminoxane, such as methyl aluminoxane (MAO), is used as cocatalyst in the polymerisation at temperatures about or greater than 40° C., the aluminoxane may dissolve and extract the metallocene catalyst from the support forming a soluble catalyst in the polymerisation medium. This soluble catalyst may deposit polymer onto the reactor walls and/or generates very small particles of low bulk density that are undesirable in a commercial reactor. Reactor fouling due to the use of aluminoxane is of particular importance for catalyst compositions based on metallocene catalyst components that require relatively high amounts of catalyst activator for their activation.

With sheeting as used herein is meant the formation of a sheet, e.g. a thin layer, of polymer material on the inside wall and/or other components on the inside of the reactor.

### SUMMARY

There exists a need for preparing a further improved catalyst composition that allows a process for the polymerization of olefins wherein fouling and/or sheeting during the process is reduced to a minimum, wherein the catalyst has high catalyst productivity, good flow properties and is relatively easy to prepare and wherein the obtained polyolefin has a high bulk density.

Accordingly, efforts continue to be done to develop solutions to contribute thereto.

The present invention contributes thereto by a process for the production of a supported metallocene catalyst system involving the steps of
(i) preparing a mixture (a) by subjecting a quantity of a compound of formula (I)

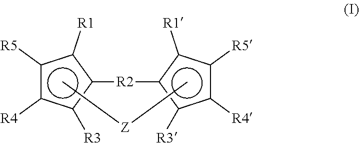

wherein:
   Z is a moiety selected from ZrX₂, HfX₂, or TiX₂, wherein X is selected from the group of halogens, alkyls, aryls and aralkyls;
   R2 is a bridging moiety containing at least one sp2 hybridised carbon atom;
   each R1, R1′, R3, R3′, R4, R4′, R5 and R5′ are hydrogen or a hydrocarbon moiety comprising 1-20 carbon atoms;
together with a quantity of a cocatalyst as solution in a hydrocarbon solvent,
preferably at a temperature of 40-80° C. for a period of 0.1-2.0 hrs;
(ii) preparing a mixture (b) by reacting a quantity of an aluminium compound of formula (II) with a quantity of an amine compound of formula (III) in a hydrocarbon solvent;

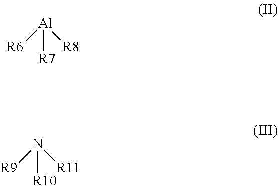

wherein R6 is hydrogen or a hydrocarbon moiety comprising 1 to 30 carbon atoms; each R7 and R8 are the same or different and are hydrocarbon moieties comprising 1 to 30 carbon atoms; R9 is hydrogen or a functional moiety comprising at least one active hydrogen; R10 is hydrogen or a hydrocarbon moiety comprising 1 to 30 carbon atoms; R11 is a hydrocarbon moiety comprising 1 to 30 carbon atoms;
(iii) providing a quantity of a support material, preferably a dehydrated support materials, into a reaction vessel;
(iv) providing a quantity of a hydrocarbon solvent into the reaction vessel;
(v) supplying the mixture (a) and the mixture (b) to the reaction vessel;
(vi) subjecting the contents of the reaction vessel to a temperature of [95° C.] for a period of >3 hrs to obtain a supported catalyst system; and
(vii) removing the hydrocarbon solvent from the supported catalyst system.

### DETAILED DESCRIPTION

It is preferred that the cocatalyst is an organoaluminum compound or a non-coordinating anionic compound, preferably the cocatalyst is a compound selected from methylaluminoxane, perfluorphenylborane, triethylammonium tetrakis(pentafluorphenyl)borate, triphenylcarbenium tetrakis(pentafluorphenyl)borate, trimethylsilyl tetrakis(pentafluorphenyl)borate, 1-pentafluorphenyl-1,4-dihydroboratabenzene, tributylammonium-1,4-bis(pentafluorphenyl)boratabenzene, and triphenylcarbenium-1-methylboratabenzene, more preferably the cocatalyst is methylaluminoxane.

Such process is believed to enhance the immobilisation of the compound of formula (I), being the metallocene compound, and the cocatalyst on the support material. When methylaluminoxane is used as cocatalyst, the process allows for deposition of an increased quantity of aluminium, such as up to 20 wt % or up to 16 wt %, onto the support and into the pores of the support. The supported metallocene catalyst system obtained via the process of the invention results in reduced formation of fines in ethylene polymerisation, and reduced sheeting in gas-phase ethylene polymerisation. The enhanced immobilisation of the metallocene compound on and in the support material is believed to lead to a reduction of leaching of metallocene in the presence of continuity agent, when such is used in a polymerisation process.

The process according to the invention results in a supported metallocene catalyst system that leads in ethylene polymerisation to reduction of hollow particle formation, thereby leading to an increased bulk density of the polymer that is obtained. Furthermore, the active catalytic species in the catalyst system produced via the process according to the invention are much more evenly distributed on and in the catalyst system particles, which leads to a reduction of hot spot formation during polymerisation.

The period of step (vi) may for example be >3.5 hrs, preferably >3.5 hrs and <6.0 hrs, more preferably ≥4.0 hrs and <6.0 hrs.

The temperature of step (vi) may for example be >75° C., preferably >75° C. and <120° C., more preferably >80° C. and <100° C.

The preparation of the mixture (a) in step (i) may for example be done at a temperature of 45-60° C. and/or for a period of 0.5-1.5 hrs.

The supported catalyst system may for example comprise ≥3.0 and ≤20.0 wt % of Al, preferably ≥9.0 and ≤18.0 wt %, more preferably ≥11.0 and ≤18.0 wt %, or ≥9.0 and ≤16.0 wt %, more preferably ≥11.0 and ≤16.0 wt %, with regard to the weight of the supported catalyst system.

The molar ratio of the cocatalyst to the compound of formula (I) may for example be ≥50 and ≤500, preferably ≥75 and ≤300, more preferably ≥100 and ≤300, or ≥200 and ≤300.

The weight ratio of the cocatalyst to the support material may for example be ≥0.1 and ≤0.8, preferably ≥0.2 and ≤0.6, more preferably ≥0.3 and ≤0.6.

The weight ratio of the compound of formula (I) to the support material may for example be ≥0.005 and ≤0.08, preferably ≥0.01 and ≤0.05, more preferably ≥0.01 and ≤0.03.

The supported catalyst system may for example contain from 0.01-5.0 wt %, preferably from 0.15-3.0 wt %, more preferably from 0.3-2.0 wt % of the mixture (b), based on the total eight of the supported catalyst system.

The amounts of the aluminium compound and the amine compound may preferably be selected such that in the mixture (b) a molar ratio of Al to N is in the range of 1:3 to 5:1, preferably 1:2 to 3:1, more preferably 1:1.5 to 1.5:1. If the molar ratio of Al to N is below 1:3 then catalyst productivity may decrease, i.e. the amount of polymer produced per gram of catalyst may decrease, whereas if the molar ratio of Al to N is above 5:1, then fouling and/or sheeting may occur.

The amine compound preferably has a hydrocarbon group of at least six carbon atoms, more preferably at least twelve carbon atoms. The amine compound is preferably a primary amine.

The amine compound may for example be selected from the group consisting of octadecylamine, ethylhexylamine, cyclohexylamine, bis(4-aminocyclohexyl)methane, hexamethylenediamine, 1,3-benzenedimethanamine, 1-amino-3-aminomethyl-3,5,5-trimethylcyclohexane and 6-amino-1,3-dimethyluracil. Preferably, the amine compound is cyclohexylamine.

The aluminium compound may be a single aluminium compound or a mixture of two or more different aluminium compounds. The aluminium compound is preferably a trialkylaluminium or a dialkylaluminiumhydride. For example, the aluminium compound of formula (II) is selected from the group consisting of of tri-methylaluminium, tri-ethylaluminium, tri-propylaluminium, tri-butylaluminium, tri-isopropylaluminium, tri-isobutylaluminium, di-methylaluminiumhydrde, di-ethylaluminiumhydrde, di-propylaluminiumhydrde, di-butylaluminiumhydride, di-isopropylaluminiumhydrde, and di-isobutylaluminiumhydrde.

The amine compound may for example be cyclohexylamine and the aluminium compound may be tri-isobutylaluminium.

In the compound according to formula I, R4 may be fused with R5 to form a 2-indenyl moiety. The 2-indenyl moiety formed by the fused R4 with R5 may be substituted or unsubstituted. R4′ may be fused with R5′ to form a 2-indenyl moiety. The 2-indenyl moiety formed by the fused R4′ with R5′ may be substituted or unsubstituted. For example, both R4 with R5 and R4′ with R5′ may be fused to each form a 2-indenyl moiety, which may be substituted or unsubstituted. It is preferred that the 2-indenyl moiety formed by fusion of R4 with R5 and the 2-indenyl moiety formed by fusion of R4′ and R5′ are the same.

In the compound according to formula I, R3 may be fused with R4 to form a 1-indenyl moiety. The 1-indenyl moiety formed by the fused R3 with R4 may be substituted or unsubstituted. R3′ may be fused with R4′ to form a 1-indenyl moiety. The 1-indenyl moiety formed by the fused R3′ with R4′ may be substituted or unsubstituted. For example, both R3 with R4 and R3′ with R4′ may be fused to each form a 1-indenyl moiety, which may be substituted or unsubstituted. It is preferred that the 1-indenyl moiety formed by fusion of R3 with R4 and the 1-indenyl moiety formed by fusion of R3′ and R4′ are the same.

Preferably, in the compound of formula I, R4 with R5 and R4′ and R5′ are fused to form a complex according to formula IV:

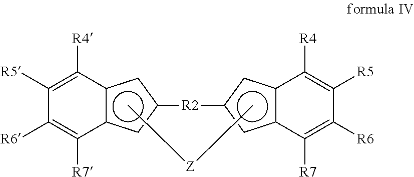

wherein:
   R2 is a bridging moiety containing at least one sp2 hybridised carbon atom;
   each R4, R4′, R7 and R7′ are hydrogen or moieties comprising 1-10 carbon atoms, wherein each R4, R4′, R7 and R7′ are the same;
   each R5, R5′, R6 and R6′ are hydrogen or moieties comprising 1-10 carbon atoms, wherein each R5, R5′, R6 and R6′ are the same; and
   Z is a moiety selected from ZrX₂, HfX₂, or TiX₂, wherein X is selected from the group of halogens, alkyls, aryls and aralkyls.

Preferably X is a monovalent anionic group, selected from the group consisting of halogen (F, Cl, Br or I), a C1-C20 hydrocarbyl group or a C1-C20 alkoxy group. Preferably X is a methyl group, Cl, Br or I, most preferably methyl or Cl. For example, Z may be a moiety selected from ZrCl₂, HfCl₂ or TiCl₂.

The bridging moiety R2 preferably is a substituted or unsubstituted methylene, 1,2-phenylene or 2,2′-biphenylene moiety. For example, R2 may be a substituted or unsubstituted 2,2′-biphenylene moiety.

The compound of formula (I) may for example be a compound selected from [ortho-bis(4-phenyl-2-indenyl)-benzene]zirconiumdichloride, [ortho-bis(5-phenyl-2-indenyl)-benzene]zirconiumdichloride, [ortho-bis(2-indenyl)benzene]zirconiumdichloride, [ortho-bis(2-indenyl)benzene]hafniumdichloride, [ortho-bis(1-methyl-2-indenyl)-benzene]zirconiumdichlorde, [2,2′-bis(2-indenyl)biphenyl]zirconiumdichlorde and [2,2′-bis(2-indenyl)biphenyl]hafniumdichloride,

For example, the compound of formula (I) may be a zirconium-containing compound selected from [2,2′-bis(2-indenyl)biphenyl]zirconium dichloride, [2,2′-bis(1-indenyl)biphenyl]zirconium dichloride, [(2-(2-indenyl)-2′-cyclopentadienyl)biphenyl]zirconium dichloride, [(2-(1-indenyl)-2′-cyclopentadienyl)biphenyl]zirconium dichloride, [(1-(1-indenyl)-1-cyclopentadienyl-1-methy)ethyl]zirconium dichloride, [(1-(2-indenyl)-1-cyclopentadienyl-1-methyl)ethyl]zirconium dichloride, [(1,1′-bis(1-indenyl)-1-methyl)-ethyl]zirconium dichloride, [(1,1′-bis(2-indenyl)-1-methyl)-ethyl]zirconium dichloride, [(1-(1-indenyl)-1-cyclopentadienyl)methyl]zirconium dichloride, [(1-(2-indenyl)-1-cyclopentadienyl)methyl]zirconium dichloride, [1,1′-bis(2-indenyl)methyl]zirconium dichloride, and [1,1′-bis(1-indenyl)methyl]zirconium dichloride.

For example, the compound of formula (I) may be a hafnium-containing compound selected from [2,2′-bis(2-indenyl)biphenyl]hafnium dichloride, [2,2′-bis(1-indenyl)biphenyl]hafnium dichloride, [(2-(2-indenyl)-2′-cyclopentadienyl)biphenyl]hafnium dichloride, [(2-(1-indenyl)-2′-cyclopentadienyl)biphenyl]hafnium dichloride, [(1-(1-indenyl)-1-cyclopentadienyl-1-methyl)ethyl]hafnium dichloride, [(1-(2-indenyl)-1-cyclopentadienyl-1-methyl)ethyl]hafnium dichloride, [(1,1′-bis(1-indenyl)-1-methyl)-ethyl]hafnium dichloride, [(1,1′-bis(2-indenyl)-1-methyl)-ethyl]hafnium dichloride, [(1-(1-indenyl)-1-cyclopentadienyl)methyl]hafnium dichloride, [(1-(2-indenyl)-1-cyclopentadienyl)methyl]hafnium dichloride, [1,1′-bis(2-indenyl)methyl]hafnium dichloride, and [1,1′-bis(1-indenyl)methyl]hafnium dichloride.

For example, the compound of formula (I) may be a titanium-containing compound selected from [2,2′-bis(2-indenyl)biphenyl]titanium dichloride, [2,2′-bis(1-indenyl)biphenyl]titanium dichloride, [(2-(2-indenyl)-2′-cyclopentadienyl)biphenyl]titanium dichloride, [(2-(1-indenyl)-2′-cyclopentadienyl)biphenyl]titanium dichloride, [(1-(1-indenyl)-1-cyclopentadienyl-1-methyl)ethyl]titanium dichloride, [(1-(2-indenyl)-1-cyclopentadienyl-1-methyl)ethyl]titanium dichloride, [(1,1′-bis(1-indenyl)-1-methyl)-ethyl]titanium dichloride, [(1,1′-bis(2-indenyl)-1-methyl)-ethyl]titanium dichloride, [(1-(1-indenyl)-1-cyclopentadienyl)methyl]titanium dichloride, [(1-(2-indenyl)-1-cyclopentadienyl)methyl]titanium dichloride, [1,1′-bis(2-indenyl)methyl]titanium dichloride, and [1,1′-bis(1-indenyl)methyl]titanium dichloride.

For example, the compound of formula (I) may be selected from [2,2′-bis(2-indenyl)biphenyl]hafnium dichloride, [2,2′-bis(2-indenyl)biphenyl]zirconium dichloride, [2,2′-bis(2-indenyl)biphenyl]titanium dichloride, [2,2′-bis(1-indenyl)biphenyl]hafnium dichloride, [2,2′-bis(1-indenyl)biphenyl]zirconium dichloride, and [2,2′-bis(1-indenyl)biphenyl]titanium dichloride. Preferably, the compound of formula (I) is [2,2′-bis(2-indenyl)biphenyl]zirconium dichloride.

Using the supported metallocene catalyst system according to the invention, a polyethylene may be produced being for example an ethylene homopolymer or an ethylene-α-olefin copolymer. The polyethylene may for example have a density of ≥850 and ≤960 kg/m³, preferably of ≥870 and ≤935 kg/m³, more preferably of ≥900 and ≤925 kg/m³. The polyethylene may for example be a copolymer comprising ≥1.0 and ≤30.0 wt %, preferably ≥3.0 and ≤20.0 wt %, more preferably ≥5.0 and ≤15.0 wt %, of moieties derived from an α-olefin having 3 to 10 carbon atoms, preferably from an α-olefin selected from 1-butene, 1-hexene, 4-methyl-1-pentene, and 1-octene.

The polyethylene preferably is produced via a gas-phase ethylene polymerisation process, more preferably a process for production of polyethylene by gas-phase polymerisation of ethylene and a further α-olefin selected from 1-butene, 1-hexene, 4-methyl-1-pentene and 1-octene. More preferably, the process is a process for production of polyethylene by gas-phase polymerisation of ethylene and ≥5.0 and ≤20.0 wt % of an α-olefin selected from 1-butene, 1-hexene, 4-methyl-1-pentene and 1-octene, with regard to the total weight of the ethylene and the α-olefin.

The feed that is introduced to the process may further comprise one or more α-olefins comprising 3 to 10 carbon atoms, preferably wherein the α-olefin comprising 3 to 10 carbon atoms is selected from 1-butene, 4-methyl-1-pentene, 1-hexene or 1-octene, preferably wherein the feed comprises ≥5.0 and ≤20.0 wt % of the α-olefin comprising 3 to 10 carbon atoms with regard to the total weight of ethylene and the α-olefin comprising 3 to 10 carbon atoms.

The process may for example be performed in a continuous gas-phase polymerisation reactor, preferably a fluidised-bed gas-phase polymerisation reactor.

Preferably, the process is continuously operated by providing to a reactor a continuous supply of reactant feed comprising ethylene, a continuous supply of the metallocene-type catalyst system, and a continuous supply of the antistatic agent, such that the molar ratio of the metallocene complex in the metallocene-type catalyst system to the antistatic agent is maintained in the range of ≥0.0001 and ≤100, preferably ≥0.001 and ≤1.0, more preferably ≥1.0 and ≤0.5, and wherein a product stream comprising the polyethylene produced in the polymerisation reactor is withdrawn continuously from the reactor. The use of the antistatic agent in such quantities contributes to the ability to operate a polyethylene polymerisation process using a metallocene-type catalyst in a continuous mode in commercial large-scale polymerisation reactors without the occurrence of sheeting.

The support material may for example be selected from a cross-linked or functionalised polystyrene, a polyvinylchloride, a cross-linked polyethylene, a silica, an alumina, a silica-alumina compound, an MgCl₂, a talc, and a zeolite, preferably wherein the support material is porous, preferably wherein the support material has an average particle size of 1 to 120 μm, more preferably 20 to 80 μm, even more preferably 40 to 50 μm. Preferably, the support material is a silica, preferably wherein the dehydrated silica is obtained by subjecting a silica to a temperature of ≥400° C., preferably of ≥400 and ≤800° C., for a period of ≥5 hrs, preferably of ≥5 hrs and ≤20 hrs.

The preferred particle size of the support is from 10 to 120 μm. Preferably, the support is silica. The pore volume of the support preferably is ≥0.5 and ≤3.0 cm³/g. Preferably, the surface area of the support material is ≥50 and ≤500 m²/g. The silica that may be employed as support in for the catalyst system preferably is dehydrated prior to use in preparation of the catalyst system. It is preferred that the supported metallocene catalyst system comprises a metallocene complex supported on a porous silica support having a particle size of from 10 to 120 μm, a pore volume of ≥0.5 and ≤3.0 cm³/g, and a surface area of ≥50 and ≤500 m²/g, as determined in accordance with ISO 9276-2 (2014).

The hydrocarbon solvent may for example be a compound selected from heptane, hexane, isopentane and toluene, preferably the hydrocarbon solvent is toluene.

The invention also relates to a supported metallocene catalyst system obtained according to the process of the invention.

In an embodiment, the invention relates to a supported metallocene catalyst system, comprising:
moieties derived from a compound of formula (I)

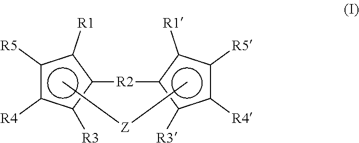

wherein:
   Z is a moiety selected from ZrX₂, HfX₂, or TiX₂, wherein X is selected from the group of halogens, alkyls, aryls and aralkyls;
   R2 is a bridging moiety containing at least one sp2 hybridised carbon atom;
   each R1, R1′, R3, R3′, R4, R4′, R5 and R5′ are hydrogen or a hydrocarbon moiety comprising 1-20 carbon atoms;
moieties derived from a cocatalyst, wherein the cocatalyst is a compound selected from methylaluminoxane, perfluorphenylborane, triethylammonium tetrakis(pentafluorphenyl)borate, triphenylcarbenium tetrakis(pentafluorphenyl)borate, trimethylsilyl tetrakis(pentafluorphenyl)borate, 1-pentafluorphenyl-1,4-dihydroboratabenzene, tributylammonium-1,4-bis(pentafluorphenyl)boratabenzene, andtriphenylcarbenium-1-methylboratabenzene, more preferably wherein the cocatalyst is methylaluminoxane; and
a support material, preferably a dehydrated support material
   wherein the supported catalyst system comprises ≥11.0 wt %, preferably ≥11.0 and ≤18.0 wt %, more preferably ≥11.0 and ≤16.0 wt %, of aluminium (Al), with regard to the weight of the supported catalyst system.

The invention will now be illustrated by the following non-limiting examples.

The materials that were used in the experiments according to the invention are presented in table 1 below.

TABLE 1
Materials used in catalyst syntheses

| | |
|---|---|
| Metallocene | [2,2′-bis(2-indenyl)biphenyl]zirconium dichloride, CAS reg. nr. 312968- |
| | 31-3 |
| Support | Silica 955W, obtainable from W. R. Grace & Co and |
| | Silica DM-M-302, obtained from AGC Inc. |
| Cocatalyst | Methyl aluminoxane (MAO), CAS reg. nr. 29429-58-1, obtainable from |
| | W. R. Grace & Co |
| Cocatalyst aid | Triisobutyl aluminium (TIBAL), CAS reg. nr. 100-99-2, obtainable from |
| | Sigma-Aldrich |
| Antistatic agent | Cyclohexylamine, CAS reg. nr. 108-91-8, obtainable from Sigma- |
| | Aldrich |
| Continuity aid agent | Composition comprising 2 wt % of a blend of the cocatalyst aid and the |
| | antistatic agent (at molar ratio 2.85:1) diluted in isopentane |

All materials were handled in a nitrogen atmosphere using either Schlenk techniques or a nitrogen filled glove box. Nitrogen and isopentane were supplied from a plant source and were dried through an additional bed of molecular sieves, if necessary. Toluene (HPLC grade, 99.9%) was purchased from Sigma-Aldrich and purged by nitrogen gas before use.

### Catalyst System Synthesis Examples

### Example 1 (Comparative)

A 3-liter autoclave reactor equipped with a heating/cooling control unit and a mechanical stirring system was baked at 150° C. (inlet oil) under a nitrogen flow for 2 hours and then cooled down to 30° C. 200 g of Grace Silica 955W pre-dehydrated at 600° C. for 10 hours was charged followed by addition of 800 ml of toluene. 2.70 g of [2,2′-bis(2-indenyl)biphenyl]zirconium dichloride was activated by mixing with 549.5 ml of a 10 wt % MAO in toluene solution at 50° C. for 30 min to obtain an activated metallocene. The activated metallocene was transferred into the autoclave reactor with stirring. The antistatic reagent modifier was prepared by reacting 0.25 g of cyclohexylamine and 0.50 g of triisobutylaluminum in 200 ml of toluene, added to the autoclave, and the reaction mixture was stirred at 50° C. for 1 hour. After drying at 75° C. under vacuum (13.5 kPa), the finished catalyst was isolated as light-yellow free-flowing powder. The catalyst contained 0.18 wt % of Zr and 9.0 wt % of Al. This resulted in a molar ratio of Al/Zr of about 169.

### Example 2 (Comparative)

A 3-liter autoclave reactor equipped with a heating/cooling control unit and a mechanical stirring system was baked at 150° C. (inlet oil) under a nitrogen flow for 2 hours and then cooled down to 30° C. 200 g of Grace Silica 955W pre-dehydrated at 600° C. for 10 hours was charged followed by addition of 800 ml of toluene. 2.70 g of [2,2′-bis(2-indenyl)biphenyl]zirconium dichloride was activated by mixing with 549.5 ml of a 10 wt % MAO toluene solution at 50° C. for 30 min to obtain an activated metallocene. The activated metallocene was transferred into the autoclave reactor with stirring. The antistatic reagent modifier was prepared by reacting 0.25 g of cyclohexylamine and 0.50 g of triisobutylaluminum in 200 ml of toluene, added to the autoclave, and the reaction mixture was stirred at 95° C. for 5 hours. After drying at 75° C. under vacuum (13.5 kPa), the finished catalyst was isolated as light-yellow free-flowing powder. The catalyst contained 0.18 wt % of Zr and 9.0 wt % of Al. This resulted in a molar ratio of Al/Zr of about 169.

### Example 3

A supported catalyst system was prepared via the synthetic procedure of Example 2, except that 2.94 g of [2,2′-bis(2-indenyl)biphenyl]zirconium dichloride, 797.5 ml of a 10 wt % MAO toluene solution, 0.27 g of cyclohexylamine and 0.54 g of triisobutylaluminum were used. The finished catalyst was isolated as light-yellow free-flowing powder. The catalyst contained 0.18 wt % of Zr and 12.0 wt % of Al. This resulted in a molar ratio of Al/Zr of about 225.

### Example 4

A supported catalyst system was prepared via the synthetic procedure of Example 2, except that 3.12 g of [2,2′-bis(2-indenyl)biphenyl]zirconium dichloride, 987.6 ml of a 10 wt % MAO toluene solution, 0.29 g of cyclohexylamine and 0.58 g of triisobutylaluminum were used. The finished catalyst was isolated as light-yellow free-flowing powder. The catalyst contained 0.18 wt % of Zr and 14.0 wt % of Al. This resulted in a molar ratio of Al/Zr of about 263.

To assess the effect of the duration of the reaction, experiments were also conducted according to the procedure as in this example 4, except that, instead of 5 hrs, a reaction period of 1 hr (Example 4b), 2 hrs (Example 4c), 3 hrs (Example 4d) and 4 hrs (Example 4e) was used. In the cases of examples 4b, 4c and 4d, the reaction mixture obtained after the reaction was orange or yellow, which indicates that the metallocene species was not completely immobilised onto the silica support. In example 4d, as well as in example 4 itself (5 hrs reaction), the reaction mixture that was obtained was colourless, indicating that the metallocene was completely immobilised on the support.

### Example 5

A supported catalyst system was prepared via the synthetic procedure of Example 2, except that 3.32 g of [2,2′-bis(2-indenyl)biphenyl]zirconium dichloride, 1203.6 ml of a 10 wt % MAO toluene solution, 0.31 g of cyclohexylamine and 0.62 g of triisobutylaluminum were used. The finished catalyst was isolated as light-yellow free-flowing powder. The catalyst contained 0.18 wt % of Zr and 16.0 wt % of Al. This resulted in a molar ratio of Al/Zr of about 301.

### Example 6

A supported catalyst system was prepared via the synthetic procedure of Example 2, except that 150 g of AGC silica DM-M-302 silica, 2.50 g of [2,2′-bis(2-indenyl)biphenyl]zirconium dichloride, 903.82 ml of a 10 wt % MAO toluene solution, 0.23 g of cyclohexylamine and 0.46 g of triisobutylaluminum were used. The finished catalyst was isolated as light-yellow free-flowing powder. The catalyst contained 0.18 wt % of Zr and 16.0 wt % of Al. This resulted in a molar ratio of Al/Zr of about 301.

### Example 7

For comparative purposes, the synthetic procedure of example 1 (i.e. at low temperature of 50° C.) was also repeated using the quantities of reactants of each of the examples 3, 4, 5 and 6. However, it was observed that, although higher quantities of MAO were supplied to the reaction mixture when regarded to the quantity of silica, the quantity of aluminium that was contained on the catalyst system that was obtained from the reaction did not increase vis-A-vis that of example 1. From that, it could be concluded that increase in aluminium loading of the catalyst system is not achievable at 50° C.

### Polymerisation Examples

The supported catalysts of Examples 1-6 were employed in polymerisation reactions in a continuous gas phase fluidized bed reactor having an internal diameter of 45 cm and a reaction zone height of 140 cm. The bed of polymer particles in the reaction zone was kept in a fluidised state by a recycle stream that acted as a fluidising medium as well as a heat dissipating agent for absorbing the exothermal heat generated within reaction zone. The reactor was kept at a constant temperature and at a constant pressure of about 2.17 MPa. Ethylene and hexene were used as the raw materials for polymerization. These materials form a make-up stream. A Continuity Aid Agent (CAA) was mixed with the make-up stream as a 2% by weight solution in isopentane carrier solvent.

In table 2, the polymerisation conditions as used in the experiments are provided.

TABLE 2
Polymerisation conditions

| Example | 8 | 9 | 10 | 11 | 12 | 13 |
|---|---|---|---|---|---|---|
| Catalyst system | Ex. 1 | Ex. 2 | Ex. 3 | Ex. 4 | Ex. 5 | Ex. 6 |
| Reactor Temperature (° C.) | 87 | 89 | 85 | 85 | 85 | 85 |
| Ethylene (mole %) | 46.1 | 46.1 | 48.4 | 48.8 | 48.1 | 48.4 |
| Hexene (mole %) | 5.44 | 5.44 | 5.36 | 5.03 | 4.77 | 4.88 |
| Continuity Aid Agent (ppm) | 100 | 100 | 100 | 100 | 100 | 100 |
| Catalyst Productivity (kg/kg) | 5,900 | 3,350 | 7,300 | 9.800 | 12,000 | 12,800 |
| Residual Ash (ppm) | 180 | 260 | 145 | <100 | <100 | <100 |
| Melt Index (dg/min) | 1.02 | 1.18 | 1.10 | 1.10 | 1.05 | 1.10 |
| Density (g/cc) | 0.9190 | 0.9190 | 0.919 | 0.9181 | 0.9173 | 0.9180 |
| Bulk Density (g/cc) | 0.373 | 0.330 | 0.408 | 0.461 | 0.474 | 0.487 |
| Fines (%) | 0.38 | 0.45 | 0.2 | 0.25 | 0.25 | 0.26 |

Wherein:
The melt index was determined in accordance with ASTM D1238 (2013) at a temperature of 190° C. under a load of 2.16 kg;
The density was determined in accordance with ASTM D1505 (2018);
The bulk density was determined by pouring the resin in a cylinder having a volume of 400 cm³, wherein the bulk density is calculated by dividing the weight of the resin by 400 to give a value in g/cm³;
The fraction of fines was determined as the percentage of the total distribution of polymer particles that passed through a 120 mesh standard sieve, wherein particles having a size of 120 μm or less passed through the sieve.

Using the polymer materials as obtained from the polymerisation examples shown above, films were produced to examine the properties thereof. The production of films involved processing the polymer resins on a Polyrema 3 layer blown film equipment. Each of the three extruders was operated at a screw speed of 20 rpm. Each of the extruders was supplied with the polymer resin to produce a blown film of 25 μm thickness, wherein the frost line height was 30 cm, the blow-up ratio was 2.5, the die gap was 2.5 mm, and the total die output was 55 kg/h. the barrel temperature of the extruder was set to 185° C. at the feed section to 220° C. at the die. The obtained films were analysed, the results of which are presented in the table 3 below.

TABLE 3
Film properties

| Example | 14 | 15 | 16 |
|---|---|---|---|
| Polymer used | Ex. 8 | Ex. 11 | Ex. 13 |
| TS at yield (MD) in MPa | 7.2 | 9.7 | 6.5 |
| TS at yield (TD) in MPa | 7.6 | 8.5 | 6.7 |
| TS at break (MD) in MPa | 18.3 | 29.4 | 15.4 |
| TS at break (TD) in MPa | 23.4 | 30.3 | 16.6 |
| Elongation at break (MD) in % | 436 | 396 | 416 |
| Elongation at break (TD) in % | 470 | 490 | 420 |
| Elongation at yield (MD) in % | 13.0 | 17.1 | 15.4 |
| Elongation at yield (TD) in % | 13.7 | 15.4 | 13.5 |
| 1% Secant modulus (MD) in MPa | 168.4 | 182.0 | 171.8 |
| 1% Secant modulus (TD) in MPa | 163.0 | 167.0 | 162.0 |
| Dart drop impact F-50 in g | 989.7 | >1271.7 | 1067.7 |
| Elmendorf tear strength (TD) in g/μm | 17.1 | 15.6 | 16.1 |
| Elmendorf tear strength (MD) in g/μm | 18.2 | 18.7 | 16.2 |
| Puncture resistance in J | 3.3 | 2.3 | 3.5 |
| Clarity in % | 94.6 | 96.6 | 94.88 |
| Gloss at 45° in gloss units (GU) | 38.8 | 40.7 | 32.9 |
| Hexane extractables in % | 0.64 | 0.73 | 0.67 |

### Wherein:

MD indicates ‘machine direction’, i.e. test performed on a sample in the direction of extrusion from the blown film, and TD indicates ‘transverse direction’, i.e. test performed in the direction perpendicular to the MD in the plane of the film;
Tensile strength, elongation and secant modulus all were determined in accordance with ASTM D882 (2018), wherein tensile strength and elongation were tested, at room temperature, using an initial sample length of 50 mm and a testing speed of 500 mm/min, and secant modulus was tested, at room temperature, using an initial sample length of 250 mm and a testing speed of 25 mm/min, using a pre-load of 1 N;
Clarity was determined as total luminous transmittance in accordance with ASTM D1003 (2013);
Gloss was determined in accordance with ASTM D2457 (2013);
Hexane extractables content was determined in accordance with ASTM D5227 (2013);
Dart drop impact F-50 was determined as W_{F} at 50% failures in accordance with ASTM D1709 (2009);
Elmendorf tear strength was determined as propagation tear resistance in accordance with ASTM D1922 (2015);
Puncture resistance was determined as energy to break in accordance with ASTM D5748-95 (2012).

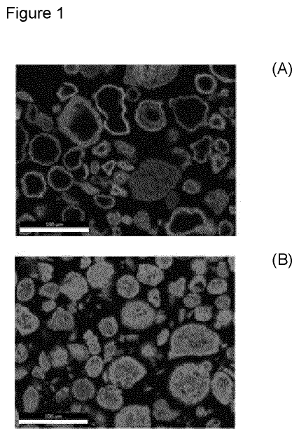

### Description of the FIG. 1

FIG. 1 shows SEM photographs of catalyst particles, showing the aluminium distribution on the catalyst particles that are obtained according to the process of the invention and according to the method of the art, wherein (A) represents a picture of a catalyst particle prepared according to the method of the art, particularly according to example 1 below, and (B) represents a picture of a catalyst prepared according to the method of the invention, particularly according to example 4 below. It can be observed that in the picture (A), the Al atoms, which cause the light colour, are present on the surface of the catalyst particles, which can be identified as the light contours surrounding the particles, whereas in the picture (B), i.e. produced according to the invention, the Al atoms are also present on the inner surface of the particles, which can be seen from the more uniform light colouration of the particles.

1. A process for the production of a supported metallocene catalyst system, the process comprising:
(i) preparing a mixture (a) by subjecting a quantity of a compound of formula (I) 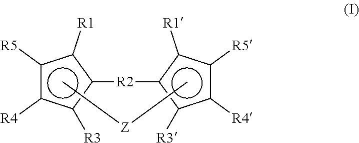
wherein:
Z is a moiety of ZrX₂, HfX₂, or TiX₂, wherein X is selected from the group consisting of halogens, alkyls, aryls and aralkyls;
R2 is a bridging moiety containing at least one sp2 hybridised carbon atom;
each R1, R1′, R3, R3′, R4, R4′, R5 and R5′ are hydrogen or a hydrocarbon moiety comprising 1-20 carbon atoms;
together with a quantity of a cocatalyst as a solution in a hydrocarbon solvent;
(ii) preparing a mixture (b) by reacting a quantity of an aluminium compound of formula (II) with a quantity of an amine compound of formula (III) in a hydrocarbon solvent; 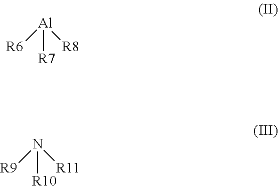
wherein R6 is hydrogen or a hydrocarbon moiety comprising 1 to 30 carbon atoms; each R7 and R8 are the same or different and are hydrocarbon moieties comprising 1 to 30 carbon atoms; R9 is hydrogen or a functional moiety comprising at least one active hydrogen; R10 is hydrogen or a hydrocarbon moiety comprising 1 to 30 carbon atoms; R11 is a hydrocarbon moiety comprising 1 to 30 carbon atoms;
(iii) providing a quantity of a support material into a reaction vessel;
(iv) providing a quantity of a hydrocarbon solvent into the reaction vessel;
(v) supplying the mixture (a) and the mixture (b) to the reaction vessel;
(vi) subjecting the contents of the reaction vessel to a temperature of >60° C. for a period of >3 hrs to obtain a supported catalyst system; and
(vii) removing the hydrocarbon solvent from the supported catalyst system.

2. The process according to claim 1, wherein the supported catalyst system comprises ≥3.0 and ≤20.0 wt % of Al, with regard to the weight of the supported catalyst system.

3. The process according to claim 1, wherein the molar ratio of the cocatalyst to the compound of formula (I) is ≥50 and ≤500.

4. The process according to claim 1, wherein the weight ratio of the cocatalyst to the support material is ≥0.1 and ≤0.8.

5. The process according to claim 1, wherein the weight ratio of the compound of formula (I) to the support material is ≥0.005 and ≤0.08.

6. The process according to claim 1, wherein the compound of formula (I) is [ortho-bis(4-phenyl-2-indenyl)-benzene]zirconiumdichloride, [ortho-bis(5-phenyl-2-indenyl)-benzene]zirconiumdichloride, [ortho-bis(2-indenyl)benzene]zirconiumdichloride, [ortho-bis(2-indenyl)benzene]hafniumdichloride, [ortho-bis(1-methyl-2-indenyl)-benzene]zirconiumdichloride, [2.2′-bis(2-indenyl)biphenyl]zirconiumdichloride, or [2,2′-bis(2-indenyl)biphenyl]hafniumdichloride,

7. The process according to claim 1, wherein the cocatalyst is an organoaluminium compound or a non-coordinating anionic compound.

8. The process according to claim 1, wherein the support material is a cross-linked or functionalised polystyrene, a polyvinylchloride, a cross-linked polyethylene, a silica, an alumina, a silica-alumina compound, an MgCl₂, a talc, or a zeolite.

9. The process according to claim 1, wherein the support material is a silica.

10. The process according to claim 1, wherein the hydrocarbon solvent is heptane, hexane, isopentane or toluene.

11. The process according to claim 1, wherein the compound of formula (II) is tri-methylaluminium, tri-ethylaluminium, tri-propylaluminium, tri-butylaluminium, tri-isopropylaluminium, tri-isobutylaluminium, di-methylaluminiumhydride, di-ethylaluminiumhydride, di-propylaluminiumhydride, di-butylaluminiumhydride, di-isopropylaluminiumhydride, or di-isobutylaluminiumhydride.

12. The process according to claim 1, wherein the compound of formula (III) is octadecylamine, ethylhexylamine, cyclohexylamine, bis(4-aminocyclohexyl)methane, hexamethylenediamine, 1,3-benzenedimethanamine, 1-amino-3-aminomethyl-3,5,5-trimethylcyclohexane, or 6-amino-1,3-dimethyluracil.

13. The process according to claim 1, wherein the period of step (vi) is >3.5 hrs; and/or
wherein the temperature of step (vi) is >75° C.

14. A supported metallocene catalyst system obtained according to the process of claim 1.

15. A supported metallocene catalyst system, comprising:
moieties derived from a compound of formula (I) 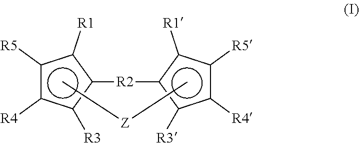
wherein:
Z is a moiety selected of ZrX₂, HfX₂, or TiX₂, wherein X is selected from the group consisting of halogens, alkyls, aryls and aralkyls;
R2 is a bridging moiety containing at least one sp2 hybridised carbon atom;
each R1, R1′, R3, R3′, R4, R4′, R5 and R5′ are hydrogen or a hydrocarbon moiety comprising 1-20 carbon atoms;
moieties derived from a cocatalyst, wherein the cocatalyst is methylaluminoxane, perfluorphenylborane, triethylammonium tetrakis(pentafluorphenyl)borate, triphenylcarbenium tetrakis(pentafluorphenyl)borate, trimethylsilyl tetrakis(pentafluorphenyl)borate, 1-pentafluorphenyl-1,4-dihydroboratabenzene, tributylammonium-1,4-bis(pentafluorphenyl)boratabenzene, or triphenylcarbenium-1-methylboratabenzene; and
a support material,
wherein the supported catalyst system comprises ≥11.0 wt %, of aluminium (Al), with regard to the weight of the supported catalyst system.
